(19) United States
(12) Patent Application Publication
(10) Pub. No.: US 2018/0310672 A1
(43) Pub. Date: Nov. 1, 2018

(54) METHOD FOR MANUFACTURING SPIKES FOR SPORTS SHOES

(71) Applicants: TREKSTA INC., Gangseo-gu (KR); DSM CO., LTD, Gimhae-si (KR); BUSAN BUSINESS SUPPORT CENTER, Yeonje-gu (KR); KOREA INSTITUTE OF FOOTWEAR LEATHER TECHNOLOGY, Busanjin-gu (KR)

(72) Inventors: Sung Won PARK, Buk-gu (KR); Jin Hoon KIM, Sasang-gu (KR); Young Seok CHOI, Gimhae-si (KR); Seon Seog SEO, Sasang-gu (KR); Seung Beom PARK, Suyeong-gu (KR); Kyung Deuk LEE, Suyeong-gu (KR); Dae Woong KIM, Yeonje-gu (KR); Jung Hyun YOO, Saha-gu (KR); Jae Min JUNG, Nam-gu (KR); Kyung Hwan PARK, Sasang-gu (KR); Myung Hun KIM, Suyeong-gu (KR); Ja Yeon PARK, Geumjeong-gu (KR); Tae Young YOON, Sasang-gu (KR)

(73) Assignees: TREKSTA INC., Gangseo-gu (KR); DSM CO., LTD, Gimhae-si (KR); BUSAN BUSINESS SUPPORT CENTER, Yeonje-gu (KR); KOREA INSTITUTE OF FOOTWEAR LEATHER TECHNOLOGY, Busanjin-gu (KR)

(21) Appl. No.: 15/736,213

(22) PCT Filed: Nov. 9, 2016
(86) PCT No.: PCT/KR2016/012845

§ 371 Date: Dec. 13, 2017

(30) Foreign Application Priority Data
Nov. 30, 2015 (KR) 10-2015-0168623

(51) Int. Cl. A43C 15/16; B29D 35/06; A43B 5/00

(52) U.S. Cl. CPC A43C 15/165; A43B 5/00; B29D 35/06

(57) ABSTRACT

The present invention relates to a method for manufacturing spikes for sports shoes, the method comprising: a primary injection-molding step for fixing a plurality of spike pin heads to one surface of a first fixed plate when injection-molding the first fixed plate such that the tip ends of the plurality of spike pins are exposed through the surface of the first fixed plate; a secondary injection-molding step for fixing a plurality of first fixed plates to one surface of a second fixed plate when injection-molding the second fixed plate, wherein the surfaces of the first fixed plates that are opposite to the surfaces to which the spike pines are fixed to the second fixed plate; and a second-fixed-plate fixing step for fixing, to the bottom of an outsole, the surface of the second fixed plate opposite to the surface to which the first fixed plates are fixed.

### TECHNICAL FIELD

The present invention relates to a method for manufacturing spikes for sports shoes, more particularly, to pins for spikes mounted on the bottom of a shoe for a bobsleigh and a method for manufacturing spikes for sports shoes for mounting such pins in an out sole.

### BACKGROUND ART

In general, a bobsleigh is games in which athletes who ride on a 2-seater or 4-seater sled whose direction can be controlled glide over a track made of snow and ice at an average speed of about 135 km. As an internal contest, the bobsleigh was adopted as a formal subject from the first Winter Olympics Games at Chamonix, France in 1924 and has lasted up to now.

In the bobsleigh games, upon start, athletes drag the sled and run forward toward the track for gliding for acceleration. When the athletes enter the track, they ride on the sled and glide on the track while controlling the direction. In this case, when the athletes accelerate before riding on the sled, slip needs to be prevented because the athletes run forward while stepping on the ice. Accordingly, several hundreds of pins for spikes, each one having a diameter of about 1˜1.5 mm, are mounted on the soles of bobsleigh shoes.

As an example of a conventional technology regarding shoes in which spikes have been mounted on the soles, there were proposed shoes equipped with spikes for slip prevention in Korean Utility Model No. 20-0238233.

However, such a shoe structure can have several hundreds of spikes mounted thereon, but is not suitable for a bobsleigh-dedicated shoe on which several hundreds of pins are mounted as described above.

Moreover, a company that manufactures bobsleigh-dedicated shoes having such a specialty has never been present in Korea and is very limited globally. Accordingly, it is necessary to develop a sports shoe which can be used as bobsleigh-dedicated shoes, and thus it is necessary to improve the development of a local shoe industry.

### PRIOR ART DOCUMENT

1. Korean Utility Model No. 20-0238233

### DISCLOSURE

### Technical Problem

An object of the present invention is to provide a method of manufacturing spikes for sports, wherein in order for a shoe to be used as a bobsleigh-dedicated shoe, pins for spikes having a small size can be mounted on the sole of a shoe conveniently and rapidly and can also be fixed to the sole firmly.

### Technical Solution

A method of manufacturing spikes for sports of the present invention for achieving the object includes a primary injection step of when injecting and forming a first fixing plate, fixing the head parts of a plurality of spike pins to one side of the first fixing plate so that tips of the plurality of spike pins are exposed on one side of the first fixing plate; a secondary injection step of when injecting and forming a second fixing plate, fixing a plurality of the first fixing plate to one side of the second fixing plate, wherein the side opposite the side to which the spike pins have been fixed in the first fixing plate is fixed; and a second fixing plate fixing step of fixing the side opposite the side to which the first fixing plates have been fixed in the second fixing plate to the bottom of an out sole, whereby the plurality of spike pins is fixed to the second fixing plate through a medium of the first fixing plates.

The method further includes a pin alignment step of penetrating the plurality of spike pins into a plurality of holes formed in a jig, respectively, and aligning the spike pins so that head parts of the spike pins are protruded on one side of the jig; a spike pin seated step of seating the head parts of the plurality of spike pins aligned by the jig into a mold for primary injection forming; and a jig separation step of separating the jig from the spike pins as processes prior to the primary injection step.

### Advantageous Effects

In accordance with the present invention, formability, workability and replacement are excellent because the plurality of spike pins is fixed to the second fixing plate through the medium of the first fixing plate and the plurality of first fixing plates is individually fixed to the second fixing plate.

Furthermore, productivity is high and mass-production is possible because the pins for spikes having a small size can be fixed and mounted on the sole of a shoe conveniently and rapidly, and durability is excellent because the pins are firmly fixed.

Moreover, the sports shoe for the bobsleigh never present in Korea has been developed because the shoe having such a specialty can be applied to a bobsleigh-dedicated shoe. Accordingly, there are effects in that the shoe industry can be developed a step further and international competitiveness can be achieved.

### DESCRIPTION OF DRAWINGS

FIG. 1 is a side view showing the structure of spikes for a sport shoe according to the present invention.

FIG. 2 is a bottom view showing the structure of the spikes for a sports shoe according to the present invention.

FIG. 3 is an enlarged view of a portion “A” in FIG. 2.

FIG. 4 is a perspective view of a spike pin for a sports shoe according to the present invention.

FIGS. 5 to 8 show a process of manufacturing the spikes for a sports shoe according to a first embodiment of the present invention. FIG. 5 is an enlarged cross-sectional view taken along line “B-B” of FIG. 3, FIG. 6 is a photograph of a sample product in the state of FIG. 5, FIG. 7 is an enlarged cross-sectional view taken along line “C-C” of FIG. 3, and FIG. 8 shows a photograph of a sample product in the state of FIG. 7.

FIG. 9 shows a process of manufacturing spikes for a sports shoe according to a second embodiment of the present invention.

### BEST MODE FOR INVENTION

The present invention includes a primary injection step of when injecting and forming a first fixing plate, fixing the head parts of a plurality of spike pins to one side of the first fixing plate so that tips of the plurality of spike pins are exposed on one side of the first fixing plate; a secondary injection step of when injecting and forming a second fixing plate, fixing a plurality of the first fixing plate to one side of the second fixing plate, wherein the side opposite the side to which the spike pins have been fixed in the first fixing plate is fixed; and a second fixing plate fixing step of fixing the side opposite the side to which the first fixing plates have been fixed in the second fixing plate to the bottom of an out sole, whereby the plurality of spike pins is fixed to the second fixing plate through a medium of the first fixing plates.

The present invention further includes a pin alignment step of penetrating the plurality of spike pins into a plurality of holes formed in a jig, respectively, and aligning the spike pins so that head parts of the spike pins are protruded on one side of the jig; a spike pin seated step of seating the head parts of the plurality of spike pins aligned by the jig into a mold for primary injection forming; and a jig separation step of separating the jig from the spike pins as processes prior to the primary injection step.

### MODE FOR INVENTION

The present invention may be changed in various manners and may have several embodiments. Hereinafter, preferred aspects of the present invention are illustrated and the present invention is described in detail based on the aspect. However, this is not intended to limit the present invention to the illustrated aspects and the spirit and technical scope of the present invention include common changes or equivalents to substitutes of the illustrated forms.

Throughout this specification, when it is described that one part is “connected” to the other part, the one part may be “directly connected” to the other part or may be “indirectly connected” to the other part through any element. When it is said that any one element is “included”, the word “include” means that another element may be added not the exclusion of any other elements, unless explicitly described to the contrary.

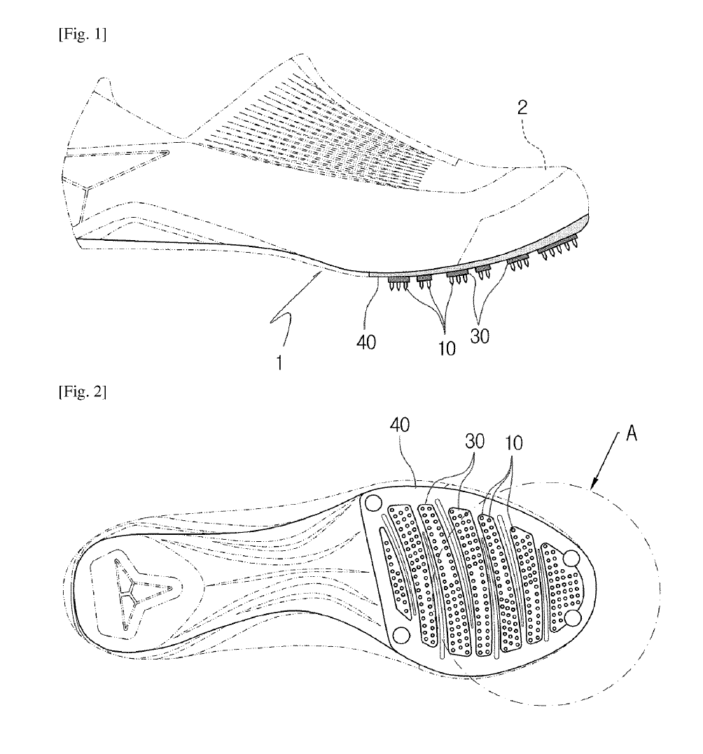

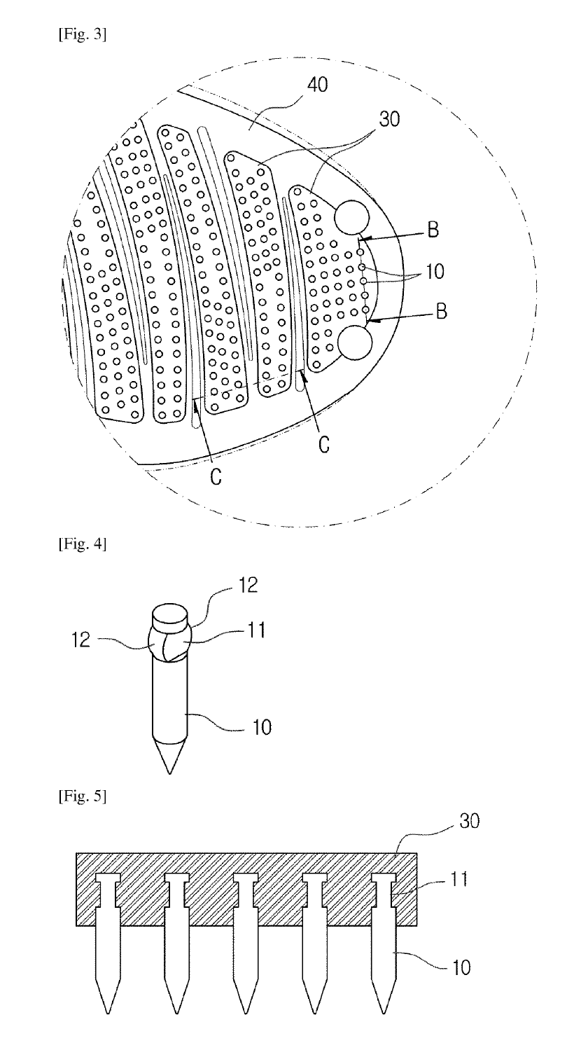

FIG. 1 is a side view showing the structure of spikes for a sport shoe according to the present invention. FIG. 2 is a bottom view showing the structure of the spikes for a sports shoe according to the present invention. FIG. 3 is an enlarged view of a portion “A” in FIG. 2. FIG. 4 is a perspective view of a spike pin for a sports shoe according to the present invention.

Referring to FIGS. 1 to 4, the uppers of leather 2 is formed on an out sole 1 for a sports shoe, and a plurality of spike pins 10 is fixed to the bottom of the out sole 1.

A maximum diameter of the spike pin 10 may be 1.5 mm or less, the length of the spike pin may be 5 mm or less, and a minimum number of spike pins 10 may be 250 so that the out sole 1 can be suitably applied to a bobsleigh shoe, in particular.

A plurality of the spike pins 10 forms one term and is fixed to a first fixing plate 30. A plurality of the first fixing plates 30 to which the plurality of spike pins 10 has been coupled is fixed to a second fixing plate 40. The second fixing plate 40 may be formed at the bottom of the out sole 1 or may be fixed to the front of part of the out sole 1 as in the shown example.

The spike pin 10 may be fabricated using a material having high strength and excellent corrosion resistance and not requiring surface processing, for example, stainless steel.

The first fixing plate 30 is an element for fixing part (head part) of the spike pins 10, and may be fabricated using a material having higher strength than common plastic and having an excellent heat-resistant property, chemical resistance and formability, for example, a polyamide-series nylon material.

The second fixing plate 40 may be fabricated using thermoplastic elastomer having a less change of hardness in a low temperature and having excellent elastic recovery, an anti-bending property, fatigue resistance and oil resistance. For example, the thermoplastic elastomer may be PEBAX (trademark).

Through such a construction, the head parts of the plurality of spike pins 10 are fixed to the second fixing plate 40 through the medium of the first fixing plate 30.

In this case, in order to improve a coupling force between each spike pin 10 and the first fixing plate 30, as shown in FIG. 4, a depressed part 11 or the depressed part 11 and a protruded part 12 may be formed at least one place in the head part of the spike pin 10.

For example, when the head part of the spike pin 10 is pressurized by a press process on one side or both sides, the pressurized portion is depressed to form the depressed part 11. Furthermore, if pressurization is increased, the remaining part other than the depressed part is externally protruded to form the protruded part 12. In this case, when the first fixing plate 30 is injected and formed, an injection melt is hardened with it being inserted into the depressed part 11. Accordingly, the spike pins 10 are firmly fixed in the first fixing plate 30, thereby being capable of preventing the detachment of the spike pins 10.

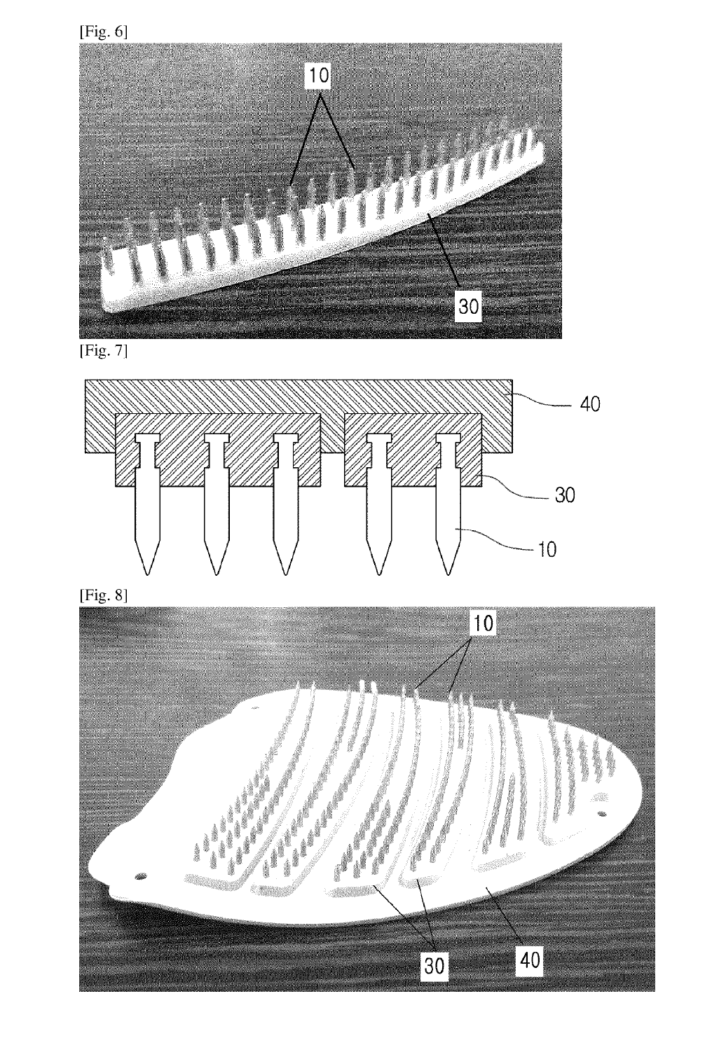

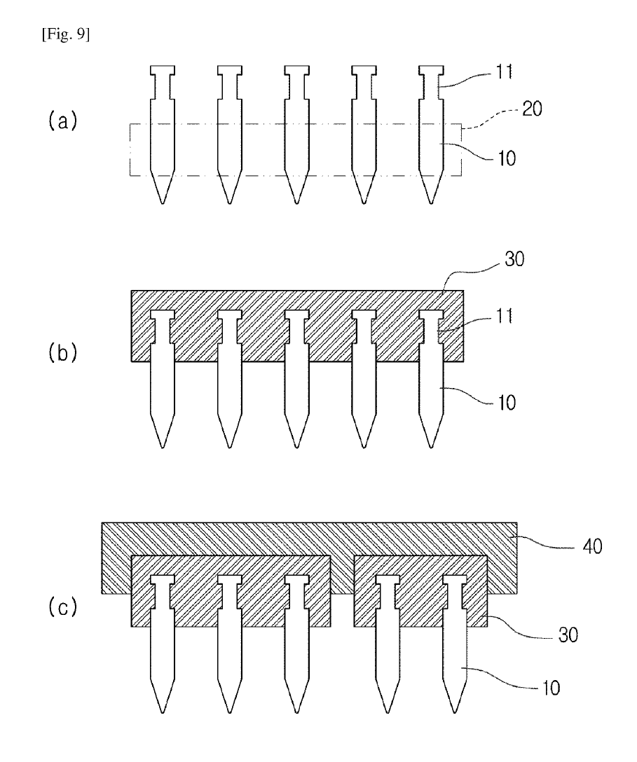

FIG. 5 is an enlarged cross-sectional view taken along line “B-B” of FIG. 3, FIG. 6 is a photograph of a sample product in the state of FIG. 5, FIG. 7 is an enlarged cross-sectional view taken along line “C-C” of FIG. 3, and FIG. 8 shows a photograph of a sample product in the state of FIG. 7.

The method of fabricating spikes for a sports shoe according to the first embodiment of the present invention includes a primary injection step of when the first fixing plate 30 is injected and formed, fixing the head parts of the plurality of spike pins 10 to one side of the first fixing plate 30 so that the tips of the plurality of spike pins 10 are exposed on one side of the first fixing plate 30, a secondary injection step of when the second fixing plate 40 is injected and formed, fixing a plurality of the first fixing plate 30 to one side of the second fixing plate 40, wherein a side opposite the side to which the spike pins 10 have been fixed in the first fixing plate 30 is fixed, and a second fixing plate fixing step of fixing a side opposite the side to which the first fixing plates 30 have been fixed in the second fixing plate 40 to the bottom of the out sole 1. Accordingly, the plurality of spike pins 10 can be fixed to the second fixing plate 40 through the medium of the first fixing plates 30.

Referring to FIG. 5, the primary injection step is a process of disposing the plurality of spike pins 10 in a mold for injecting and forming the first fixing plate 30 and forming the first fixing plate 30 by injecting a synthetic resin melt for injecting the first fixing plate 30 into the mold.

When the first fixing plate 30 is formed, the tips of the spike pins 10 are inserted into holes for seating the spike pins 10, formed in the cavity of the mold, and then fixed thereto. When injection and forming are performed, the head parts of the spike pins 10 are inserted into the first fixing plate 30 and fixed thereto. Accordingly, the spike pins 10 can be integrated with the first fixing plate 30.

In this case, the coupling force of the spike pins 10 can be enhanced because the melt for the first fixing plate 30 has been filled into the depressed parts 11 formed in the head parts of the spike pins 10 and hardened.

Such a primary injection step may be performed using an insert injection scheme, for example, but the present invention is not limited to the illustrated insert injection forming method only.

Referring to FIG. 6, the secondary injection step is a process of disposing a plurality of the first fixing plates 30 formed in the primary injection step in the mold for injecting and forming the second fixing plate 40 and forming the second fixing plate 40 by injecting a synthetic resin melt for injecting the second fixing plate 40 into the mold.

When the second fixing plate 40 is formed, the side opposite the side to which parts (spike pins) of the first fixing plate 30 have been fixed is coupled to the second fixing plate 40. Accordingly, the plurality of first fixing plates 30 can be integrated and coupled with the second fixing plate 40.

In such a secondary injection step, the secondary injection forming of the second fixing plate 40 may be performed using a dual injection forming scheme for injecting and forming the second fixing plate 40 twice in a single mold for injection with a time lag.

That is, if dual injection is applied, after the spike pins 10 are inserted into a single mold, the spike pins 10 may be fixed to the first fixing plates 30 through primary injection forming. The mold is turned upside down. When the first fixing plates 30 are fixed to the second fixing plate 40 through secondary injection forming, all of the spike pins 10 can be fixed to the single second fixing plate 40. In the present invention, the secondary injection step is not limited to the dual injection forming scheme. A mold for forming the first fixing plate 30 and a mold for forming the second fixing plate 40 may be separately fabricated.

In accordance with such a process, all of the spike pins 10 can be fixed to the second fixing plate 40 using the first fixing plate 30 as media. In this case, since the plurality of first fixing plates 30 is individually fixed to the second fixing plate 40, formability and workability are excellent, a cost can be reduced when the mold is replaced, and mass-production is possible.

The second fixing plate 40 may be formed on the entire area of the out sole 1 for a sports shoe or may be partially formed in the out sole 1 for a sports shoe.

That is, the fixing plate 40 may be fixed to the entire bottom of the out sole 1 and may be fixed to only the front of the out sole 1 as in the illustrated example. In this case, the second fixing plate 40 may be fixed to the bottom of the out sole 1 through adhesives, etc.

To this end, the step of fixing the second fixing plate to the out sole 1 may adopt a method of attaching the other side of the second fixing plate 40 to which the spike pins 10 have not been fixed and the bottom of the front of the out sole 1 by coating the other side and the bottom with adhesives or of attaching them using a hot melting scheme.

As described above, since the plurality of spike pins 10 is disposed at the front of the out sole 1, a slip can be effectively prevented by the spike pins 10 when the elbow of a foot of an athlete who has worn a sports shoe touches the ground.

FIG. 9 shows a process of manufacturing the spikes for a sports shoe according to a second embodiment of the present invention.

Referring to FIG. 9, the process of fabricating the spikes for a sports shoe according to a second embodiment of the present invention includes:

as processes prior to the primary injection step, includes a pin alignment step [(a) of FIG. 9] of penetrating the plurality of spike pins 10 into a plurality of holes formed in a jig 20, respectively, and aligning the spike pins so that the head parts of the spike pins are protruded on one side of the jig 20, a spike pin seated step of seating the head parts of the plurality of spike pins 10 aligned by the jig 20 into a mold for primary injection forming, and a jig separation step of separating the jig 20 from the spike pins 10. Thereafter, as described above, the primary injection step [(b) of FIG. 9] of fixing the head parts of the plurality of spike pins 10 to the first fixing plate 30, the secondary injection step [(c) of FIG. 9] of fastening a plurality of first fixing plates 30 to the second fixing plate 40, and the step of fixing the second fixing plate to the out sole 1 may be performed.

The pin alignment step is a process of aligning the plurality of spike pins 10 using the jig 20 as in (a) of FIG. 9.

A plurality of holes for fixing the respective pins 10 has been formed in the jig 20 in order to temporarily fix the plurality of spike pins 10 at specific intervals. The plurality of spike pins 10 can maintain a desired alignment form or interval depending on the locations of the holes.

The form or structure of the jig 20 is not limited if the jig can temporarily fix the spike pins 10 in the primary injection step until the spike pins are inserted into.

The primary injection step, as in (b) of FIG. 9, is a process of disposing the plurality of spike pins 10 temporarily fixed to the jig 20 in a mold for injecting and forming the first fixing plate 30, separating the jig 20 from the spike pins 10, and forming the first fixing plate 30 by injecting a synthetic resin melt for injecting the first fixing plate 30 into the mold.

If the jig 20 is used, workability can be improved because the plurality of spike pins 10 can be inserted into a mold at once.

In addition to the primary injection step, the secondary injection step, such as (c) of FIG. 9 and the step of fixing the second fixing plate to the out sole 1 are the same as those described with reference to FIGS. 5 and 6, and thus a redundant description thereof is omitted.

As described above, the present invention has been described in connection with the limited embodiments showing the technical spirit of the present invention, but the present invention is not limited to the specific embodiments or shapes or numbers and may be modified and changed by a person having ordinary skill in the art to which the present invention pertains without departing from the gist of the present invention, such as changing or mixing some of the elements of the embodiments. Such modification and changes should not be individually understood from the technical spirit or prospect of the present invention.

1: A method of fabricating spikes for a sports shoe, comprising:
a primary injection step of when injecting and forming a first fixing plate, fixing head parts of a plurality of spike pins to one side of the first fixing plate so that tips of the plurality of spike pins are exposed on one side of the first fixing plate;
a secondary injection step of when injecting and forming a second fixing plate, fixing a plurality of the first fixing plate to one side of the second fixing plate, wherein a side opposite the side to which the spike pins have been fixed in the first fixing plate; and
a second fixing plate fixing step of fixing a side opposite the side to which the first fixing plates have been fixed in the second fixing plate to a bottom of an out sole, whereby the plurality of spike pins is fixed to the second fixing plate through a medium of the first fixing plates,
wherein the method further comprises:
a pin alignment step of penetrating the plurality of spike pins into a plurality of holes formed in a jig, respectively, and aligning the spike pins so that head parts of the spike pins are protruded on one side of the jig;
a spike pin seated step of seating the head parts of the plurality of spike pins aligned by the jig into a mold for primary injection forming; and
a jig separation step of separating the jig from the spike pins as processes prior to the primary injection step.

2: The method of claim 1, wherein:
as a process prior to the primary injection step, a depressed part is formed at least one place of the head part of the spike pin by pressurizing the head part using a press; and
in the primary injection step, a meld for the first fixing plate is able to be inserted into the depressed part.

3: The method of claim 1, wherein the second fixing plate is fixed to an entire surface of the bottom of the out sole or fixed to only a front of the out sole.
